(19) United States
(12) Patent Application Publication
(10) Pub. No.: US 2017/0277283 A1
(43) Pub. Date: Sep. 28, 2017

(54) MOUSE WHEEL ASSEMBLY

(71) Applicants: DEXIN ELECTRONIC LTD., DONGGAUN GUANGDONG (CN); DEXIN CORPORATION, NEW TAIPEI CITY (TW)

(72) Inventor: PAN-CHUN CHAO, NEW TAIPEI CITY (TW)

(21) Appl. No.: 15/081,579

(22) Filed: Mar. 25, 2016

(51) Int. Cl. G06F 3/0362; G06F 3/0354

(52) U.S. Cl. CPC G06F 3/0362; G06F 3/03543

(57) ABSTRACT

A mouse wheel assembly is provided according to the present invention. The mouse wheel assembly includes a locating frame, a swing frame, and a scroll wheel. The swing frame is pivoted on the locating frame through a shaft and moved up and down relative to the locating frame. The scroll wheel is disposed in the swing frame and rotated relative to the swing frame. The bottom side of the swing frame is formed with a platen. The swing frame is rotated relative to the locating frame by a predetermined angle when the scroll wheel is depressed, so the platen is pressed against the micro switch.

### BACKGROUND OF THE INVENTION

### 1. Field of the Invention

The present invention is related to a mouse wheel assembly, more particularly, to a mouse wheel assembly that is easy to press.

### 2. Description of Related Art

Mice and keyboards are commonly used computer peripheral apparatus for controlling the movement of a cursor on a display screen.

A regular mouse includes a left button, a right button, and a scroll wheel. When the user views the contents of a computer file, such as a text document, spreadsheet, digital photograph, or web page, it may possess a size exceeding the viewable boundaries of the display screen by the scroll wheel of the mouse device, and so an optical sensor installed inside the mouse device is utilized to measure the rotation of the scroll wheel. Typically, the scroll wheel is partially exposed from the housing of the mouse device. Prior art U.S. Pat. No. 5,912,661 provides a conventional mouse device. A micro switch of the traditional mouse device is disposed in the left side of the scroll wheel, and a pivot of the scroll wheel is configured to press against the micro switch, so the scroll wheel is difficult to be pressed and is certainly tilted. Moreover, the tilted scroll wheel cannot be precisely controlled.

In summary, the inventor of this instant disclosure has contributed to research and developed the mouse device with pre-stress regulating structures of the instant disclosure to overcome the abovementioned drawbacks.

### SUMMARY OF THE INVENTION

The object of the instant disclosure is to provide a mouse wheel assembly that is easy to be pressed.

In order to overcome the abovementioned problem, the present invention provides the mouse wheel assembly. The mouse wheel assembly is adapted for a mouse device, and the mouse device has a micro switch. The mouse wheel assembly includes a locating frame, a swing frame, and a scroll wheel. The swing frame is pivoted on the locating frame through a shaft and moved up and down relative to the locating frame. The scroll wheel is disposed in the swing frame and rotated relative to the swing frame. The bottom side of the swing frame is formed with a platen. The swing frame is rotated relative to the locating frame by a predetermined angle when the scroll wheel is depressed, so the platen is pressed against the micro switch.

The mouse wheel assembly according to the present invention comprises a first centre and a second centre. An axis of the shaft is defined as a first centre, and an axis of the scroll wheel is defined as a second centre. A distance from the first centre to the second centre is defined as a swing radius, and a swing circumference is with a center at the first centre and a radius of the swing radius. A portion where the platen is abutted against the micro switch is defined as a pressing point, and the pressing point is located at the swing circumference.

The present invention provides a mouse wheel assembly. The mouse wheel assembly includes a first arm and a second arm. An axis of rotation of the shaft is defined as a first centre, and an axis of rotation of the scroll wheel is defined as a second centre, a distance from the first centre to the second centre is defined as the first arm. A portion where the platen is abutted against the micro switch is defined as a pressing point, and a distance from the first centre to the pressing point is defined as the second arm, and the second arm length is less than or equal to that of the first arm.

The instant disclosure has the following advantages. The force of pressing the scroll wheel by the user is delivered to the platen through the swing frame movable relative to the locating frame, and the micro switch is depressed accordingly, so as to make pressing the scroll wheel save even more effort.

In order to further appreciate the characteristics and technical contents of the present invention, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a schematic diagram of a mouse wheel assembly in the instant disclosure;

FIG. 2 shows a perspective view of the mouse wheel assembly in the instant disclosure;

FIG. 3 shows another perspective of the mouse wheel assembly in the instant disclosure;

FIG. 4 shows an exploded view of the mouse wheel assembly in the instant disclosure;

FIG. 5 shows another exploded view of the mouse wheel assembly in the instant disclosure;

FIG. 6 shows a section view of the mouse wheel assembly in the instant disclosure;

FIG. 7 shows a first schematic diagram of the mouse wheel assembly in the instant disclosure;

FIG. 8 shows a second schematic diagram of the mouse wheel assembly in the instant disclosure;

FIG. 9 shows a third schematic diagram of the mouse wheel assembly in the instant disclosure; and

FIG. 10 shows a schematic diagram of another embodiment of the mouse wheel assembly in the instant disclosure.

### DETAILED DESCRIPTION OF THE PREFERRED EMBODIMENTS

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions are provided in regard to certain aspects as non-limiting examples. However, it will be apparent to those skilled in the art that the subject technology may be practiced without these specific details. In some instances, well-known structures and components are shown in order to avoid obscuring the concepts of the subject technology. Like components are labeled with identical element numbers for ease of understanding. Reference numbers may have letter suffixes appended to indicate separate instances of a common element while being referred to generically by the same number without a suffix letter.

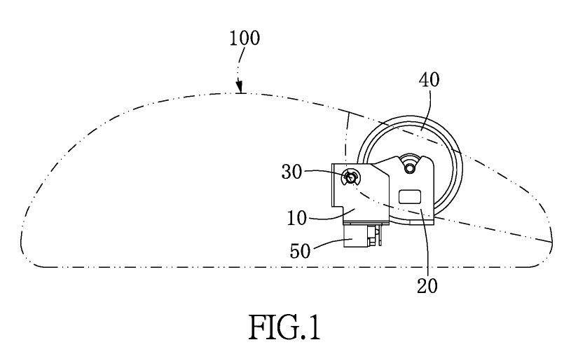

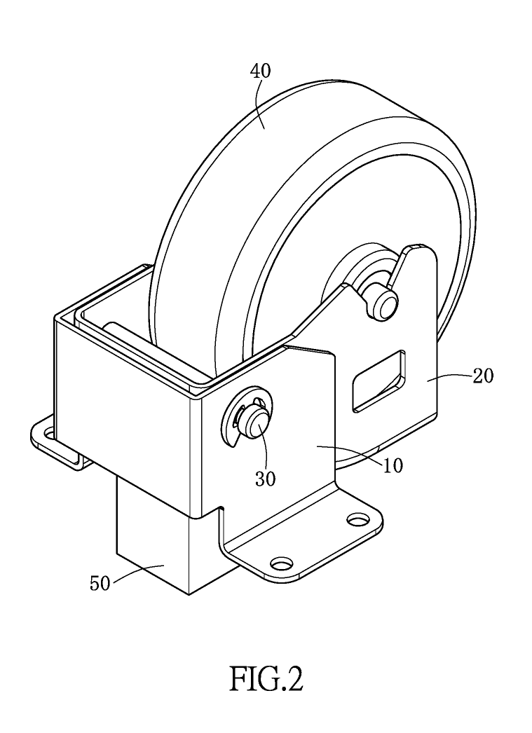

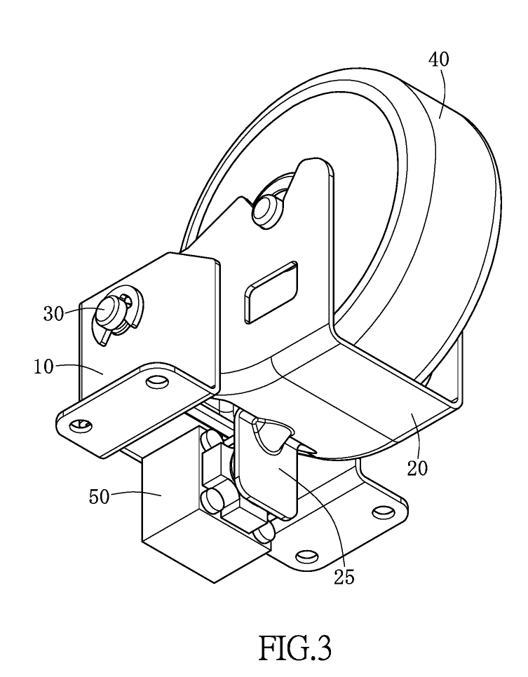

Please refer to FIGS. 1 to 6. The instant disclosure provides a mouse wheel assembly. The mouse wheel assembly is adapted for a mouse device 100, and the mouse device 100 has a micro switch 50. The mouse wheel assembly according to the present invention includes a locating frame 10, a swing frame 20, a shaft 30, and a scroll wheel 40. The swing frame 20 is pivoted on the locating frame 10 through the shaft 30 and moved up and down relative to the locating frame 10. The scroll wheel 40 is disposed in the swing frame 20 and rotated relative to the swing frame 20. The bottom side of the swing frame 20 is formed with a platen 25. The swing frame 20 is rotated relative to the locating frame 10 by a predetermined angle when the scroll wheel 40 is depressed, so the platen 25 is pressed against the micro switch 50.

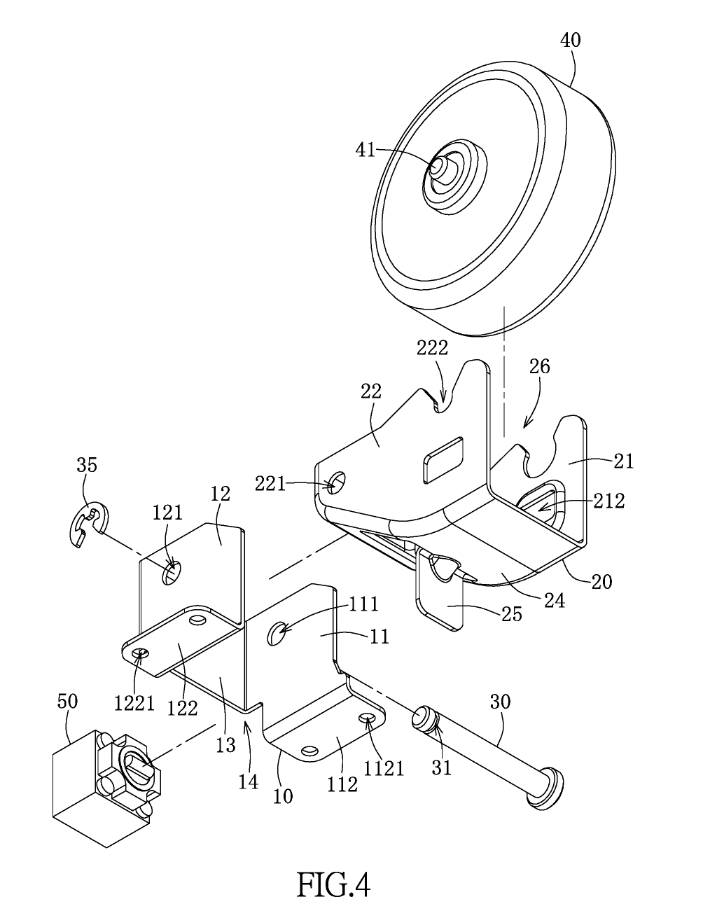

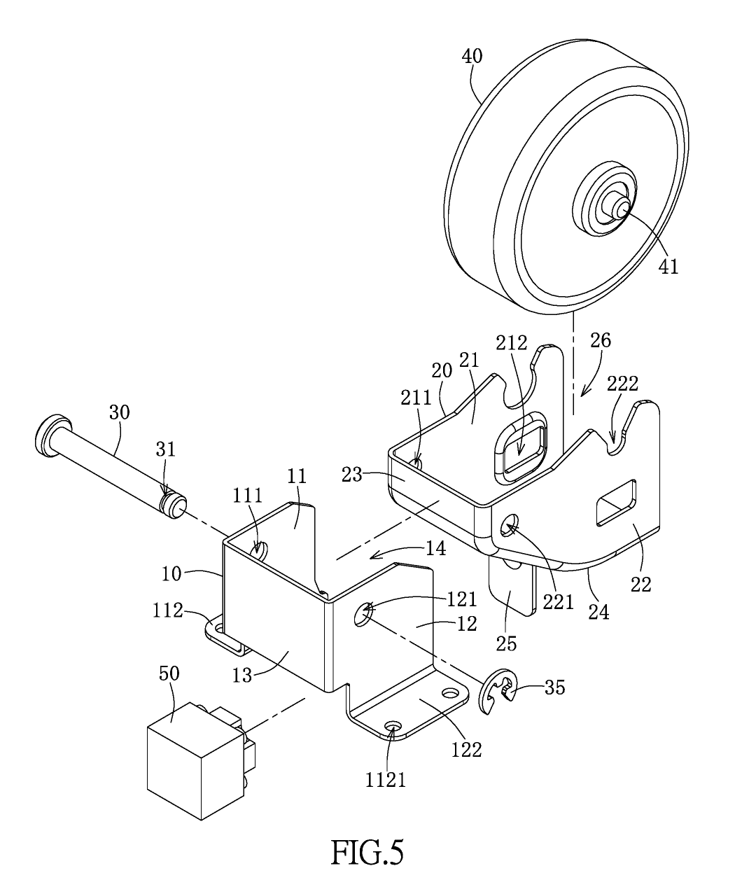

Please refer to FIGS. 4 and 5. The locating frame 10 includes a first wall 11, a second wall 12, and a third wall 13 connected to the first wall 11 and the second wall 12. The first wall 11, the second wall 12, and the third wall 13 form a first space 14. The first wall 11 is formed with a first circular hole 111 therein, and the second wall 12 is formed with a second circular hole 121 therein.

The swing frame 20 includes a first barrier 21, a second barrier 22, and a third barrier 23 connected to the first barrier 21 and the second barrier 22. An inclined portion 24 is connected to the first barrier 21, the second barrier 22, and the third barrier 23. The inclined portion 24, the first barrier 21, the second barrier 22, and the third barrier 23 form a second space 26. The first barrier 21 is formed with a first round hole 211, and the second barrier 22 is formed with a second round hole 221 corresponding to the first round hole 211. The bottom side of the swing frame 20 is formed with a platen 25 configured to press against the micro switch 50.

The shaft 30 penetrates through the first circular hole 111 of the first wall 11 of the locating frame 10, the first round hole 211 of the first barrier 21 of the swing frame 20, the second round hole 221 of the second barrier 22, and the second circular hole 121 of the second wall 12 of the locating frame 10. The swing frame 20 is accommodated in the first space 14 of the locating frame 10. The swing frame 20 is pivoted on the locating frame 10 through the shaft 30 and moved up and down relative to the locating frame 10. In this embodiment, the mouse wheel assembly of the present invention further comprises a buckle 35, and one end of the shaft 30 is formed with a slot 31 corresponding to the buckle 35. The buckle 35 is squeezed on the slot 31 to prevent the shaft 30 being detached from the first circular hole 111 of the first wall 11 of the locating frame 10, the second circular hole 121 of the second wall 12 of the locating frame 10, the first round hole 211 of the first barrier 21 of the swing frame 20, and the second round hole 221 of the second barrier 22 of the swing frame 20.

In this embodiment, the locating frame further comprises a first floor 112 and a second floor 122. More specifically, the first floor 112 is extended horizontally from one end of the first wall 11, and the second floor 122 is extended horizontally from one end of the second wall 12. The first floor 112 is formed with a first bolt hole 1121, and the second floor 122 is formed with a second bolt hole 1221. Screws (not shown) penetrate through the first bolt hole 1121 of the first floor 112 and the second bolt hole 1221 of the second floor 122, so the locating frame 10 is fixed firmly in the mouse device 100 (as shown in FIG. 1). The first barrier 21 is formed with a hatch 212 configured to expose part of the scroll wheel 40 for measuring the rotation of the scroll wheel 40 by an optical module (not shown). The second barrier 22 is formed with a recess 222, so the pivot 41 of the scroll wheel 40 is pivoted on the recess 222.

The platen 25 is formed in the inclined portion 24 of the bottom side of the swing frame 20. In this embodiment, the inclined portion 24 is made by a punching and stamping process. The platen 25 may be, but not limited to, a bump, a protrusion, a stick, or a plate. In this embodiment, the platen 25 is with a platelike shape, and the platen 25 and the swing frame 20 are built in one piece, but the platen 25 and the swing frame 20 certainly can be individual parts and combined together later on.

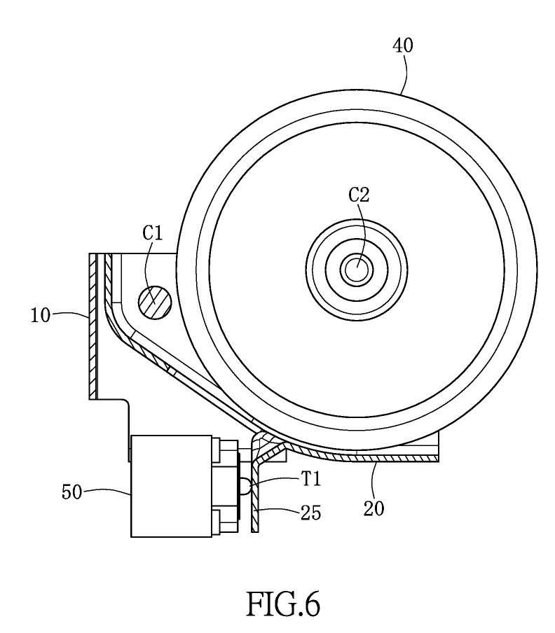

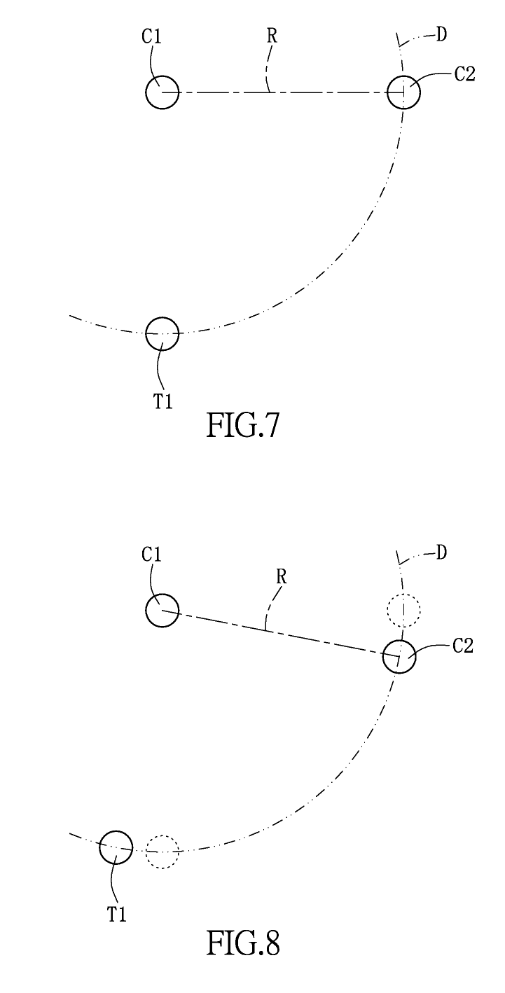

Please refer to FIGS. 6, 7 and 8. In this embodiment, the axis of rotation of the shaft 30 is defined as a first centre C1, and the axis of rotation of the pivot 41 of the scroll wheel 40 is defined as a second centre C2. A distance from the first centre C1 to the second centre C2 is defined as a swing radius R. A swing circumference D has a center at the first centre C1 and a radius of the swing radius R. A portion where the platen 25 is abutted against the micro switch 50 is defined as a pressing point T1, and the pressing point T1 is located at the swing circumference D.

The swing frame 20 is rotated relative to the locating frame 10 by a predetermined angle when the user presses the scroll wheel 40, so the platen 25 disposed in the bottom side of the swing frame 20 is pressed against the micro switch 50 accordingly. In other words, the second centre C2 and the pressing point T1 move back and forward along the swing circumference D, so the pressing force of the scroll wheel 40 is delivered to the platen 25 directly and make pressing the scroll wheel 40 save even more effort.

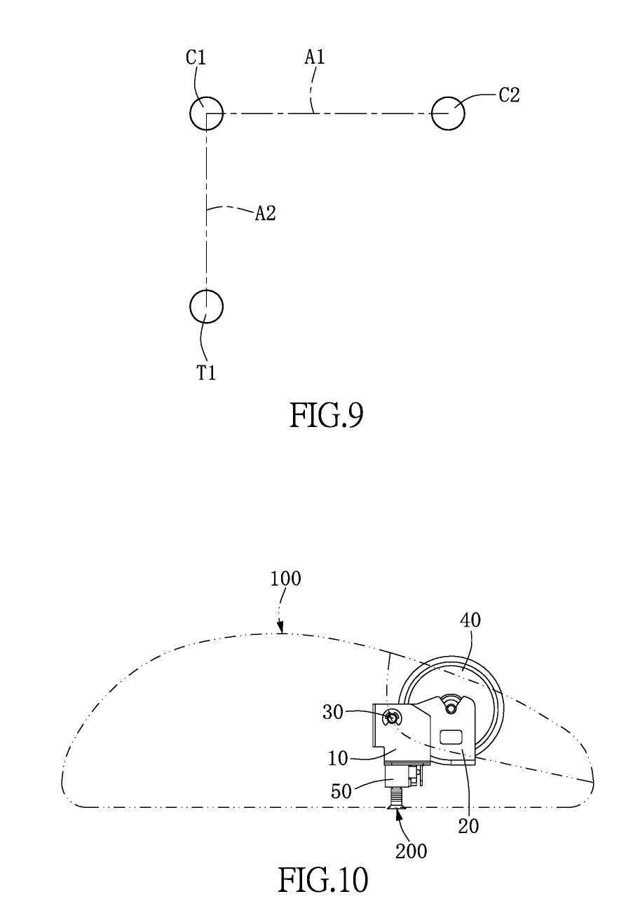

The pressing point T1 may be not located at the swing circumference D. Please refer to FIG. 9, the axis of rotation of the shaft 30 is defined as a first centre C1, the axis of rotation of the scroll wheel 40 is defined as a second centre C2, and a portion where the platen 25 is abutted against the micro switch 50 is defined as a pressing point T1. A distance from the first centre C1 to the second centre C2 is defined as a first arm A1. A distance from the first centre C1 to the pressing point T1 is defined as a second arm A2. The second arm length A2 is less than or equal to that of the first arm A1. More specifically, when the second arm length A2 is equal to that of the first arm A1, the pressing force of the scroll wheel 40 is delivered through the swing frame 20 to the platen 25 for pressing against the micro switch 50. In the case that the second arm length A2 is less than that of the first arm A1, lesser pressing force is needed to depress the scroll wheel 40, saving effort. Please refer to FIGS. 9 and 10. The present invention provides another embodiment, a regulating screw 200 is disposed below the micro switch 50, and a rail (not shown) is disposed adjacent to the micro switch 50. The micro switch 50 can move along the rail, and the regulating screw 200 can be rotated to adjust the length of the second arm A2, so the second arm length A2 is less or equal to that of the first arm A1.

To sum up, the mouse wheel assembly of the instant disclosure overcomes the problem of the tilt of the scroll wheel in the conventional mouse device. According to the mouse wheel assembly of the instant disclosure, the swing frame is depressed and the platen of the swing frame presses against the micro switch of the mouse device, so the scroll wheel is not tilted and pressing the scroll wheel saves even more effort.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A mouse wheel assembly adapted for a mouse device, and the mouse device has a micro switch, comprising:
a locating frame,
a swing frame pivoted on the locating frame through a shaft and moved up and down relative to the locating frame, and
a scroll wheel disposed in the swing frame and rotated relative to the swing frame,
wherein a bottom side of the swing frame is formed with a platen, and the swing frame is rotated relative to the locating frame by a predetermined angle when the scroll wheel is depressed, so the platen is pressed against the micro switch.

2. The mouse wheel assembly according to claim 1, wherein an axis of the shaft is defined as a first centre, and an axis of the scroll wheel is defined as a second centre, a distance from the first centre to the second centre is defined as a swing radius, and a swing circumference is with a center at the first centre and a radius of the swing radius, and a portion where the platen is abutted against the micro switch is defined as a pressing point, and the pressing point is located at the swing circumference.

3. The mouse wheel assembly according to claim 1, wherein an axis of rotation of the shaft is defined as a first centre, and an axis of rotation of the scroll wheel is defined as a second centre, a distance from the first centre to the second centre is defined as a first arm, and a portion where the platen is abutted against the micro switch is defined as a pressing point, a distance from the first centre to the pressing point is defined as a second arm, and the second arm length is less than or equal to that of the first arm.

4. The mouse wheel assembly according to claim 1, wherein the locating frame comprises a first wall, a second wall, and a third wall connected to the first wall and the second wall, the first wall is formed with a first circular hole, the second wall is formed with a second circular hole corresponding to the first circular hole, the shaft penetrates the first circular hole and the second circular hole.

5. The mouse wheel assembly according to claim 4, wherein a first floor is extended horizontally from one end of the first wall, and a second floor is extended horizontally from one end of the second wall.

6. The mouse wheel assembly according to claim 1, wherein the swing frame comprises a first barrier, a second barrier, and a third barrier connected to the first barrier and the second barrier, and the first wall is formed with a first round hole, the second wall is formed with a second round hole corresponding the first round hole, and the shaft penetrates the first round hole and the second round hole.

7. The mouse wheel assembly according to claim 6, wherein the second barrier of the swing frame is formed with a recess, and a pivot of the scroll wheel is pivoted on the recess.

8. The mouse wheel assembly according to claim 6, wherein the first barrier further comprises a hatch.

9. The mouse wheel assembly according to claim 6, wherein the swing frame comprises an inclined portion connected to the first barrier, the second barrier, and the third barrier, and the platen is formed in the inclined portion.

10. The mouse wheel assembly according to claim 1, wherein the mouse wheel assembly further comprises a buckle, and one end of the shaft is formed with a slot corresponding to the buckle.
